(19) United States
(12) Patent Application Publication
(10) Pub. No.: US 2025/0392976 A1
(43) Pub. Date: Dec. 25, 2025

(54) ALLOCATING IP ADDRESSES TO USER PLANE FUNCTIONS FOR EFFICIENT ROUTING TABLE SIZE MANAGEMENT

(71) Applicant: T-Mobile USA, Inc., Bellevue, WA (US)

(72) Inventors: Kameswaran Arunachalam, Redmond, WA (US); Hemchand Manikonda, Renton, WA (US)

(21) Appl. No.: 18/752,618

(22) Filed: Jun. 24, 2024

(51) Int. Cl. H04W 40/28; H04L 45/02; H04W 80/04; H04W 80/10

(52) U.S. Cl. CPC H04W 40/28; H04L 45/04; H04W 80/04; H04W 80/10

(57) ABSTRACT

A device for wireless communication is disclosed. The device determines a pool of internet protocol (IP) addresses for multiple user plane (UP) racks. Each UP rack comprises multiple user plane functions (UPFs) connected to the device. The multiple UP racks are further connected to a network switch or an aggregation router gateway (ARG) in a telecommunications network. The device divides the pool of IP addresses into multiple IP address blocks, each IP address block forming a unique subnet in the pool of IP addresses. The device assigns each unique subnet IP address block to a UP rack.

### BACKGROUND

A subnetwork, or subnet, is a logical subdivision of an internet protocol (IP)-based network. The practice of dividing a network into two or more networks is called subnetting. Computers that belong to the same subnet are addressed with an identical group of its most significant bits of their IP addresses. This results in the logical division of an IP address into two fields: the network number, also known as the routing prefix, and the rest field, also known as the host identifier. The rest field is an identifier for a specific host or network interface. A supernetwork, or supernet, is an IP-based network that is formed by aggregation of multiple networks or subnets into a larger network. The new routing prefix for the aggregate network represents the constituent networks in a single routing table entry.

The routing prefix can be expressed as the first address of a network, written in Classless Inter-Domain Routing (CIDR) notation, followed by a slash character (/) and ending with the bit-length of the prefix. For example, 198.51.100.0/24 is the prefix of the IP version 4 (IPv4) network starting at the given address, having 24 bits allocated for the network prefix and the remaining 8 bits reserved for host addressing. Addresses in the range 198.51.100.0 to 198.51.100.255 belong to this network, with 198.51.100.255 as the subnet broadcast address. The IP version 6 (IPv6) address specification 2001:db8::/32 is a large IP address block with 296 addresses, having a 32-bit routing prefix.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram of a system in which at least some aspects of the disclosed technology are implemented.

FIG. 4 is a flowchart of a method for implementing at least some aspects of the disclosed technology.

FIG. 5 is a flowchart of a method for implementing some other aspects of the disclosed technology.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to a method and system for allocating internet protocol (IP) address ranges by a Session Management Function (SMF) of a telecommunications network to a plurality of user plane functions (UPFs) of the telecommunications network. In some embodiments, the SMF is configured to reserve a unique pool of IP prefixes for a user plane (UP) rack that houses a plurality of user plane functions (UPFs). From that unique pool, the SMF assigns IP address blocks to individual UPFs within the UP rack. The UP rack advertises the pool of IP addresses assigned to it to a top-of-the-rack (ToR) network switch disposed in the UP rack. The ToR network switch further advertises the pool of IP addresses to an aggregation router gateway (ARG) that is communicatively coupled to it. In some embodiments, individual UPFs in the UP rack advertise, to the ToR network switch, the IP address blocks assigned to them by the SMF. The ToR network switch then summarizes the individual IP address blocks by extracting a network subnet prefix from the IP address blocks. The network subnet prefix is the common portion of the IP address blocks. The ToR network switch advertises the extracted network subnet prefix to an aggregation router gateway (ARG) that is communicatively coupled to the ToR network switch. In some embodiments, individual UPFs within a UP rack summarize the IP address blocks assigned to them by the SMF and advertise the summarized IP address block, e.g., the extracted network subnet prefix, to the ToR network switch disposed in the UP rack containing the UPFs.

One of the key components of virtually any layer-2 or layer-3 network switch is the Ternary Content Addressable Memory (TCAM). Here, the terms layer-2 and layer-3 refer to layers 2 and 3, respectively, of the Open Systems Interconnection (OSI) model. The TCAM is a high-speed, specialized memory used in routers and network devices. Unlike conventional Random Access Memory (RAM) or DRAM (Dynamic RAM), TCAM memory is designed to accelerate the forwarding and routing of packets in real time. TCAM is an expensive component and is typically a scarce resource on a switch or a router. As such, to speed up routing of packets, the inventors have recognized a need to efficiently manage contents of the TCAM on board the ToR network switch in each UP rack and on board each ARG in the telecommunications network, thereby reducing the number of IP addresses entries in their respective TCAM.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

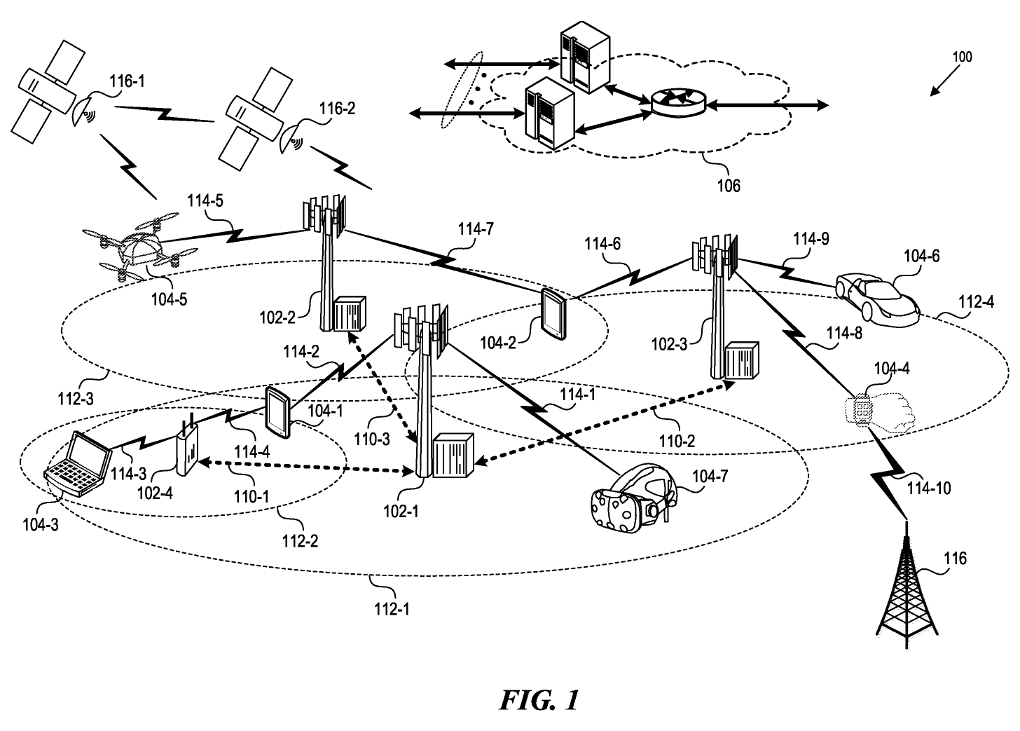

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

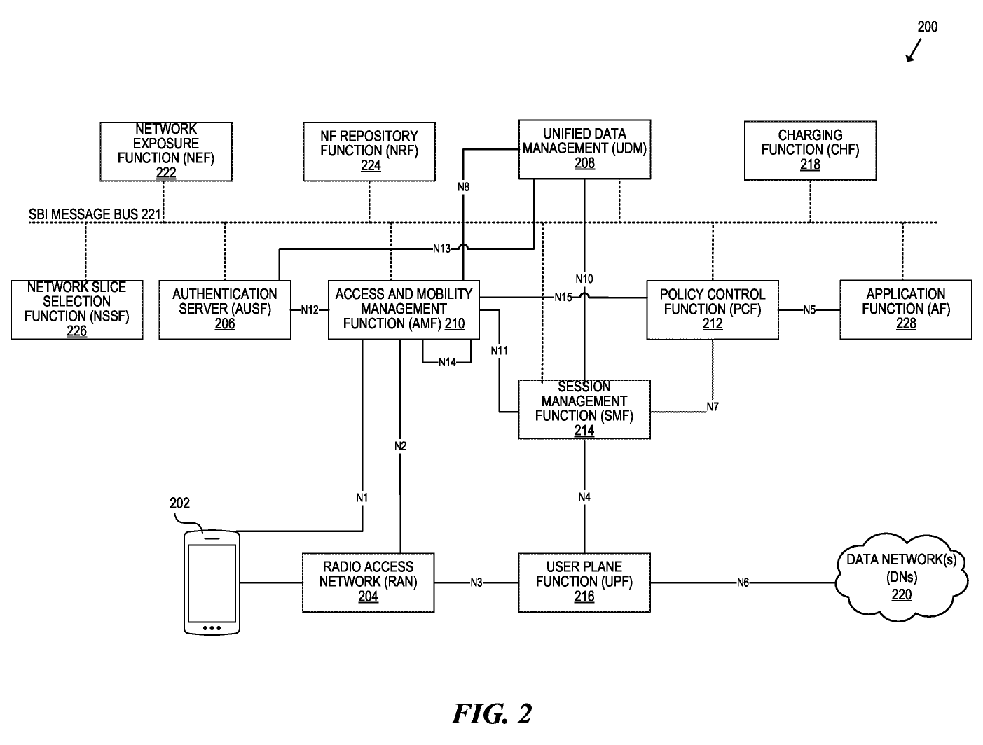

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Allocation of IP Addresses to User Plane Functions for Efficient Routing Table Size Management

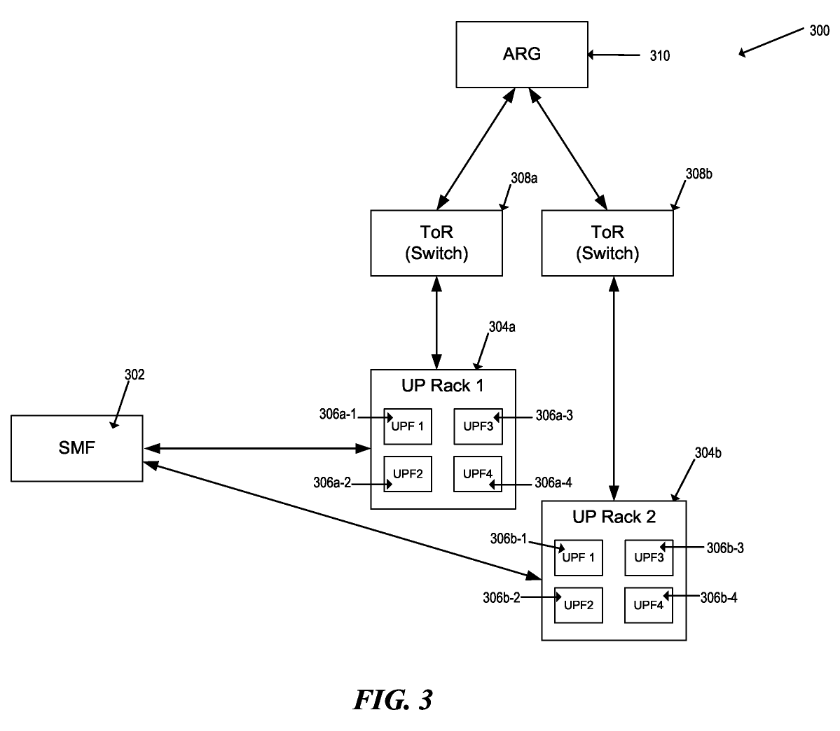

FIG. 3 is a block diagram of a system 300 in which at least some aspects of the disclosed technology are implemented. Session Management Function (SMF) 302 is a hardware or software network element disposed in the telecommunications network. The SMF 302 is communicatively coupled with a plurality of user plane (UP) racks. In one example, the SMF 302 is communicatively coupled with UP racks 304a and 304b. Collectively, UP racks 304a and 304b can be referred to as UP racks 304. UP racks 304a and 304b are each configured to include a plurality of user plane functions (UPFs). In one example, UP rack 304a can include UPFs 306a-1 to 306a-4 and UP rack 304b can include UPFs 306b-1 to 306b-4. A UP rack can include more or less than four UPFs as per the capacity needs and network dimensioning principles followed by the operator of the telecommunications network. Collectively, UPFs 306a-1-306a-4 included in UP rack 304a can be referred to as 306a and UPFs 306b-1-306b-4 included in UP rack 304b can be referred to as 306b, respectively. Collectively, all UPFs in UP racks 304a and 304b can be referred to as 306.

UP rack 304a includes a top-of-the-rack (ToR) network switch 308a that serves as a communication gateway of the UP rack 304a and its included UPFs 306a. Similarly, UP rack 304b includes a top-of-the-rack (ToR) network switch 308b that serves as a communication gateway of the UP rack 304b and its included UPFs 306b. Collectively, the ToR network switches 308a and 308b of UP racks 304a and 304b, respectively, can be referred to as ToR network switches 308. The ToR network switches 308 are communicatively coupled with an aggregation router gateway (ARG) 310 disposed in the telecommunications network.

The ARG 310 serves as a layer-3 network router that is communicatively coupled with at least one network element of the telecommunications network. Data packets originating from a UE connected to UPF 306 of UP rack 304 are passed from the UPF 306 to the ToR network switch 308. The ToR network switch 308, in turn, routes the data packets to ARG 310, which, in turn, routes them to at least one other network element disposed in the telecommunications network for routing to a destination of the data packets. Similarly, data packets destined to a UE connected to UPF 306 are received by the ARG 310 from at least one network element disposed in the telecommunications network and routed to ToR network switch 308, which, in turn, routes the data packets to UPF 306 for further routing them to the UE.

In some embodiments, the plurality of UPFs 306 is deployed in one or more user plane (UP) racks 304, with each UP rack 304 comprising a plurality of servers, each server further corresponding to a UPF 306 in the UP rack 304. In some embodiments, each UP rack 304 is communicatively coupled with the rest of the telecommunications network via a top-of-the-rack (ToR) network switch 308, which is, in turn, communicatively coupled with a layer-3 aggregation router gateway (ARG) 310 disposed in the telecommunications network. The SMF 302 is configured to allocate an IP address to each user equipment (UE) connected to each UPF 306. Conventionally, the SMF 302 can be configured to randomly assign IP addresses to different UEs connected to different UPFs 306, with each UPF 306 configured to advertise to the ToR network switch 308 IP addresses assigned by the SMF 302 to UEs connected to that UPF 306 and with the ToR network switch 308 of each UP rack 304, in turn, configured to advertise to the ARG 310 IP addresses randomly assigned by the SMF 302 to all UEs connected to UPFs 306 in the UP rack 304.

In some embodiments, the SMF 302 is configured to allocate IP addresses to UEs connected to a first UPF 306a-1 from a first range of IP addresses corresponding to a first subnet, UEs connected to a second UPF 306a-2 from a second range of IP addresses corresponding to a second subnet, and so on. Further, the SMF 302 is configured to allocate IP addresses to UEs connected to UPFs 306a from a first UP rack 304a from a first range of IP addresses corresponding to a first supernet, UEs connected to UPFs 306b from a second UP rack 304b from a second range of IP addresses corresponding to a second supernet, and so on, such that the supernet of each UP rack 304 comprises subnets of UPFs 306 within that UP rack 304. In another embodiment of the disclosed technology, the ToR network switch 308 is further configured to summarize into a supernet identifier IP addresses assigned to UEs connected to UPFs 306 in the UP rack 304 and to advertise the supernet identifier to the ARG 310. In yet another implementation of the disclosed technology, each UPF 306 is configured to summarize into a supernet identifier IP addresses assigned to UEs connected to the UPF 306 and to advertise the supernet identifier to the ToR network switch 308 of the UP rack 304 to which the UPF 306 belongs.

Each UPF 306 in the telecommunications network can be configured to handle data sessions of up to 100000 UEs, with each UE assigned a unique IP address by the SMF 302. Each UP rack 304 and its associated ToR network switch 308 can be configured to handle up to 30 UPFs 306 each. Thus, the TCAM of each ToR network switch 308 can contain up to 3 million IP address entries, resulting in a very high utilization of the TCAM space in the ToR. As a result, for each incoming data packet, the ToR network switch 308 can be required to search through 3 million entries to identify the correct route to forward the packet. Similarly, in some implementations, each ARG 310 in the telecommunications network can be communicatively coupled with a plurality of ToR network switches 308, with each ToR network switch 308 advertising up to 3 million IP addresses as described above. As a result, for each incoming data packet, the ARG 310 can be required to search through millions of entries to identify the correct route to forward the packet.

Searching through the up to 3 million randomly assigned IP addresses can slow down the forwarding of data packets. In some implementations, the SMF 302 is configured to allocate IP addresses in two blocks—for example, 2607:fb90:8a00::/44 and 2607:fb90:8a10::/44. Each of these two blocks represents 1 million IP addresses. The SMF 302 can divide the IP address supernet block 2607:fb90:8a00::/44 into 64 IP address subnet blocks: from 2607:fb90:8a00::/50 to 2607:fb90:8a0f:c000::/50. Similarly, the SMF 302 can divide the IP address supernet block 2607:fb90:8a10::/44 into 64 IP address subnet blocks: 2607:fb90:8a10::/50 to 2607:fb90:8a1f:c000::/50. Thus, the SMF 302 can divide the two supernet blocks 2607:fb90:8a00::/44 and 2607:fb90:8a10::/44, each of size /44, into 128 subnet blocks, each of size /50, and randomly assign them to a plurality of UPFs 306 across a plurality of UP racks 304. As a result, the ToR network switch 308 of each UP rack 304 learns 64 routes from the plurality of UPFs 306 within that UPF rack 304 and advertises the same routes to the ARG 310. Thus, the ARG 310 also learns 64 routes from each ToR network switch 308 communicatively coupled to it. As such, each ARG 310 and ToR network switch 308 in the telecommunications network receives a large number of routes or IP prefix chunks from the plurality of UPFs 306 in the network, resulting in a large routing table size and high TCAM utilization. As an operational consideration, the operator of the telecommunications network is then required to install additional ToR network switches 308 and ARGs in the network, thereby increasing capital and operational expenditure.

Furthermore, when a UE initiates a connection request to a radio access network (RAN), the RAN includes the Tracking Area Code (TAC) information of the UE in the request and forwards the request to an AMF or mobility management entity(MME) disposed in the network. The telecommunications network selects an SMF 302 or packet data network (PDN) gateway (PGW) to process the request by engaging a network repository function (NRF) or a domain name system (DNS) query based on a type of radio access technology (RAT) supported by the UE. The selected SMF 302 then sends the session to a UPF 306 communicatively coupled to the SMF 302. The SMF 302 is configured to assign to the UPF 306 an IP prefix block selected by the operator of the telecommunications network. The SMF 302 is configured to monitor a utilization of IP prefix blocks assigned to each UPF 306 communicatively coupled to the SMF 302. When the utilization of an IP prefix block at a UPF 306 reaches a configurable threshold, the SMF 302 assigns a new IP prefix block to the UPF 306. Each IP prefix block assigned by the SMF 302 to the UPF 306 is advertised to by the UPF 306 to ToR network switch 308 of the UP rack 304 of the UPF 306 and is further advertised by the ToR network switch 308 to the ARG 310. As a result, as more IP prefix blocks are assigned to UPFs 306, TCAM (route table) utilization of the ToR network switch 308 and the ARG 310 increases. When the TCAM utilization reaches a threshold value, the operator is required to clean up the TCAM table by either removing some legitimate TCAM entries, resulting in service outages, or adding more ToR network switches 308 and ARGs 310 to the network, resulting in increased capital and operational expenditure.

This patent document discloses technology that can be implemented to enable the ToR network switch 308 of each UP rack 304 to learn a single route of the supernet of the ToR network switch 308 from the plurality of UPFs 306 within that UPF rack 304 and advertises that supernet route to the ARG 310 so as to lower operational expenditure. The ARG 310 also learns only a single route of the supernet of each ToR network switch 308 communicatively coupled to it. As a result, the routing table size or TCAM utilization of the ToR network switch 308 and the ARG 310 is reduced 64-fold, from 64 entries, each corresponding to a subnet of each UPF 306 included in the UP rack 304, to a single entry corresponding to the supernet of all UPFs 306 included in the UP rack 304.

In some embodiments, the telecommunications network can include a 5G standalone (SA) core network. In some embodiments, the telecommunications network can include a 5G non-standalone (NSA) core network that operates alongside or in combination with a 4G Long-Term Evolution (LTE)/System Architecture Evolution (SAE) network. In some embodiments, the telecommunications network can include a converged core network that provides both 4G LTE and 5G services. In some embodiments, the IP addresses can belong to IPv4. In some embodiments, the IP addresses can belong to IPv6.

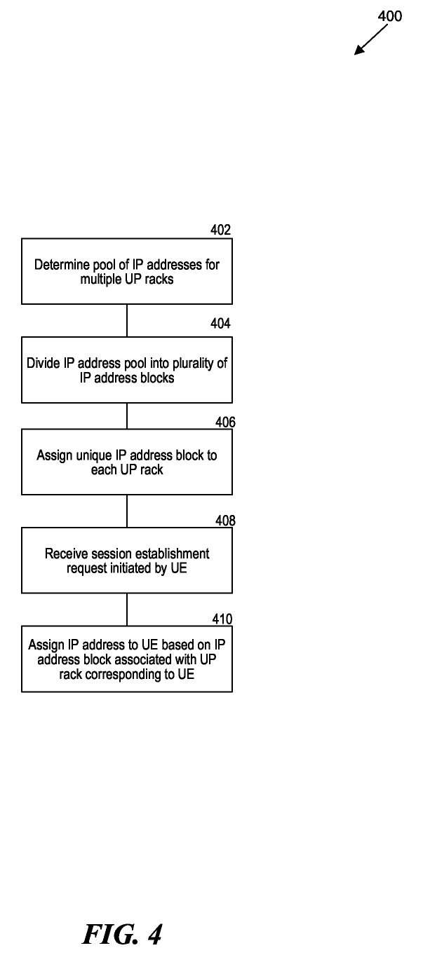

FIG. 4 is a flowchart of a method 400 for implementing at least some aspects of the disclosed technology. The method is implemented in a device for wireless communication comprising at least one hardware processor and at least one non-transitory memory storing instructions. In some embodiments, the device can be a Session Management Function (SMF) disposed in the telecommunications network. At 402, the device determines a pool of internet protocol (IP) addresses for multiple user plane (UP) racks. Each UP rack comprises a plurality of user plane functions (UPFs) communicatively coupled with the device. The multiple UP racks are further communicatively coupled with a network switch or an aggregation router gateway (ARG) disposed in a telecommunications network. At 404, the device divides the pool of IP addresses into a plurality of IP address blocks, with each of the plurality of IP address blocks forming a unique subnet in the pool of IP addresses. At 406, the device assigns each unique subnet IP address block to a UP rack. At 408, the device receives a session establishment request initiated from a user equipment (UE). At 410, in response to the session establishment request, the device assigns an IP address to the UE based on the IP address block associated with the UP rack corresponding to the UE.

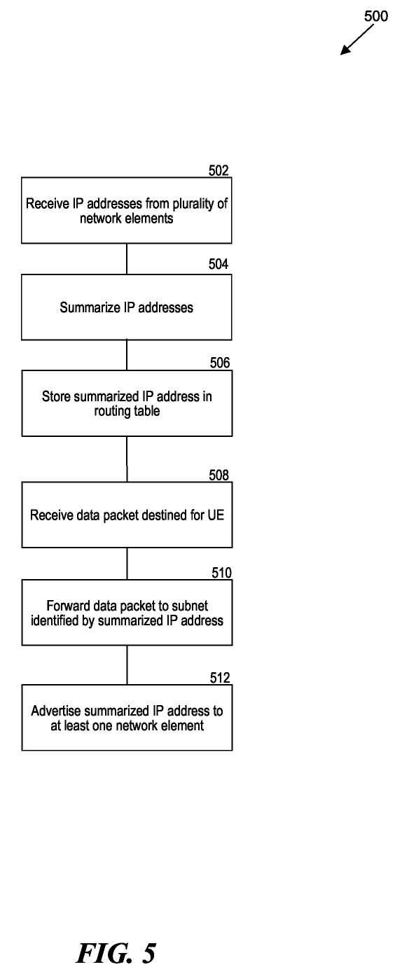

FIG. 5 is a flowchart of a method 500 for implementing some other aspects of the disclosed technology. The method can be implemented in a device for wireless communication comprising at least one hardware processor and at least one non-transitory memory storing instructions. In some embodiments, the device is a user plane function (UPF) disposed on a user plane (UP) rack disposed in a telecommunications network. In some embodiments, the device is a top-of-the-rack (ToR) network switch disposed on a user plane (UP) rack disposed in a telecommunications network. At 502, the device receives, from a plurality of network elements communicatively coupled with the device, internet protocol (IP) addresses of each of the plurality of network elements. In some embodiments, the plurality of network elements from which the device receives IP addresses includes a user plane function (UPF) disposed in a telecommunications network. In some embodiments, the plurality of network elements from which the device receives IP addresses includes a user plane (UP) rack disposed in a telecommunications network. The UP rack includes at least one user plane function (UPF) disposed in the UP rack. At 504, the device summarizes the IP addresses received from the plurality of network elements. Summarizing the IP addresses received from the plurality of network elements comprises extracting a network subnet prefix from the IP addresses by identifying an IP address block that forms a common part of each of the IP addresses. At 506, the device stores the summarized IP address in a routing table of the device. At 508, the device receives a data packet destined to a user equipment (UE) served by a network element with an IP address belonging to the IP address block. At 510, the device, in response to receiving the data packet, forwards the data packet to the network subnet identified by the summarized IP address. At 512, the device advertises the summarized IP addresses to at least one network element communicatively coupled to the device by communicating the summarized IP address to the at least one network element. In some embodiments, the network element to which the device advertises the summarized IP addresses is a top-of-the-rack (ToR) network switch disposed in a user plane (UP) rack disposed in a telecommunications network. The UP rack includes at least one user plane function (UPF) disposed in the UP rack. In some embodiments, the network element to which the device advertises the summarized IP addresses is an aggregation router gateway (ARG) disposed in a telecommunications network.

### Computer System

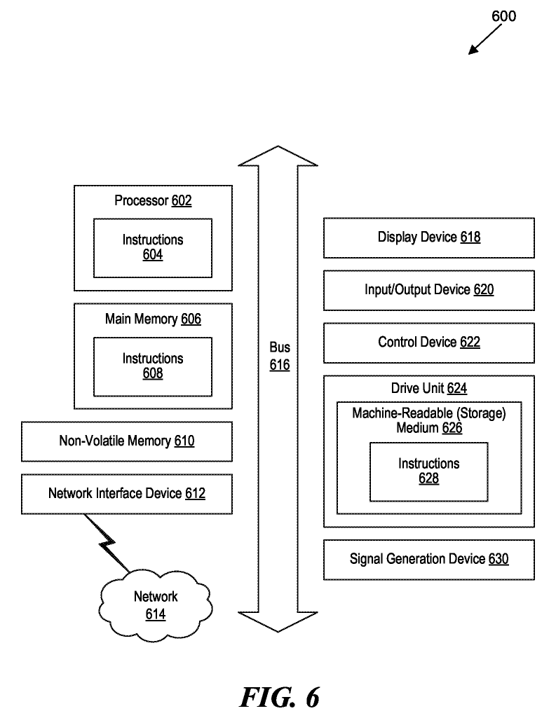

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A device for wireless communication, comprising:
at least one hardware processor; and
at least one non-transitory memory storing instructions, which, when executed by the at least one hardware processor, cause the device to:
determine a pool of internet protocol (IP) addresses for multiple user plane (UP) racks,
wherein each UP rack comprises a plurality of user plane functions (UPF) communicatively coupled with the device, and
wherein the multiple UP racks are further communicatively coupled with a network switch or an aggregation router gateway (ARG) disposed in a telecommunications network;
divide the pool of IP addresses into a plurality of IP address blocks, each of the plurality of IP address blocks forming a unique subnet in the pool of IP addresses; and
assign each unique subnet IP address block to a UP rack.

2. The device of claim 1, wherein the at least one hardware processor is configured to:
receive a session establishment request initiated from a user equipment (UE); and
in response to the session establishment request, assign an IP address to the UE based on the IP address block associated with the UP rack corresponding to the UE.

3. The device of claim 1, wherein the device comprises a Session Management Function (SMF) disposed in the telecommunications network.

4. A device for wireless communication, comprising:
at least one hardware processor; and
at least one non-transitory memory storing instructions, which, when executed by the at least one hardware processor, cause the device to:
receive, from a plurality of network elements communicatively coupled with the device, internet protocol (IP) addresses of each of the plurality of network elements; and
summarize the IP addresses received from the plurality of network elements,
wherein summarizing the IP addresses received from the plurality of network elements comprises extracting a network subnet prefix from the IP addresses by identifying an IP address block that forms a common part of each of the IP addresses.

5. The device of claim 4, further caused to:
store the summarized IP address in a routing table of the device;
receive a data packet destined to a user equipment (UE) served by a network element with an IP address belonging to the IP address block; and
in response to receiving the data packet, forward the data packet to the network subnet identified by the summarized IP address.

6. The device of claim 4, further caused to:
advertise the summarized IP addresses to at least one network element communicatively coupled to the device by communicating the summarized IP address to the at least one network element.

7. The device of claim 4, wherein the plurality of network elements from which the device receives IP addresses includes a user plane function (UPF) disposed in a telecommunications network.

8. The device of claim 4, wherein the plurality of network elements from which the device receives IP addresses includes a user plane (UP) rack disposed in a telecommunications network, and wherein the UP rack includes at least one user plane function (UPF) disposed in the UP rack.

9. The device of claim 4, wherein the network element to which the device is caused to advertise the summarized IP addresses comprises a top-of-the-rack (ToR) network switch disposed in a user plane (UP) rack disposed in a telecommunications network, and wherein the UP rack includes at least one user plane function (UPF) disposed in the UP rack.

10. The device of claim 4, wherein the network element to which the device is caused to advertise the summarized IP addresses comprises an aggregation router gateway (ARG) disposed in a telecommunications network.

11. The device of claim 4, wherein the device is a user plane function (UPF) disposed on a user plane (UP) rack disposed in a telecommunications network.

12. The device of claim 4, wherein the device is a top-of-the-rack (ToR) network switch disposed on a user plane (UP) rack disposed in a telecommunications network.

13. A method for wireless communication, the method comprising, by a device:
receiving, from a plurality of network elements communicatively coupled with the device, internet protocol (IP) addresses of each of the plurality of network elements; and
summarizing the IP addresses received from the plurality of network elements,
wherein summarizing the IP addresses received from the plurality of network elements comprises extracting a network subnet prefix from the IP addresses by identifying an IP address block that forms a common part of each of the IP addresses.

14. The method of claim 13, further comprising:
storing the summarized IP address in a routing table of the device;
receiving a data packet destined to a user equipment (UE) served by a network element with an IP address belonging to the IP address block; and
in response to receiving the data packet, forwarding the data packet to the network subnet identified by the summarized IP address.

15. The method of claim 13 further comprising:
advertising the summarized IP addresses to at least one network element communicatively coupled to the device by communicating the summarized IP address to the at least one network element.

16. The method of claim 13 wherein receiving IP addresses from a plurality of network elements comprises:
receiving IP addresses from a user plane function (UPF) disposed in a telecommunications network.

17. The method of claim 13 wherein receiving IP addresses from a plurality of network elements comprises:
receiving IP addresses from a user plane (UP) rack disposed in a telecommunications network,
wherein the UP rack includes at least one user plane function (UPF) disposed in the UP rack.

18. The method of claim 13 wherein advertising the summarized IP addresses to a network element comprises:
advertising the summarized IP addresses to a top-of-the-rack (ToR) network switch disposed in a user plane (UP) rack disposed in a telecommunications network,
wherein the UP rack includes at least one user plane function (UPF) disposed in the UP rack.

19. The method of claim 13 wherein advertising the summarized IP addresses to a network element comprises:
advertising the summarized IP addresses to an aggregation router gateway (ARG) disposed in a telecommunications network.

20. The method of claim 13 wherein the device is a top-of-the-rack (ToR) network switch disposed on a user plane (UP) rack disposed in a telecommunications network.
